(19) United States
(12) Patent Application Publication
(10) Pub. No.: US 2019/0128331 A1
(43) Pub. Date: May 2, 2019

(54) Connection Arrangement

(71) Applicant: ContiTech Techno-Chemie GmbH, Karben (DE)

(72) Inventor: Stefan Zahradnik, Schotten-Michelbach (DE)

(21) Appl. No.: 16/094,418

(22) PCT Filed: Feb. 13, 2017
(86) PCT No.: PCT/EP2017/053129

§ 371 Date: Oct. 17, 2018

(30) Foreign Application Priority Data
Apr. 18, 2016 (DE) 10 2016 206 471.1

(51) Int. Cl. F16D 1/068; F16D 1/08

(52) U.S. Cl. CPC F16D 1/068; F16C 2361/41; F16D 1/0858

(57) ABSTRACT

Connection arrangement between a shaft and a bore, wherein the connection can be produced via a pressing operation and a subsequent soldering operation. An object on which the invention is based is to improve a connection arrangement in such a manner that sufficient wetting of the components with solder is provided even in unfavorable circumstances in terms of fit and that, before the soldering operation, the connection between the pressed-in shaft and bore has at least one gap. The circumferential length of the at least one gap and/or the sum of all the circumferential lengths of the gaps is less than the circumferential length of the bore. The resulting gaps have a gap width between 0.05 and 0.2 mm, preferably 0.1 mm. With these gap widths, it is possible to achieve a particularly good flow of solder during soldering.

### CROSS REFERENCE TO RELATED APPLICATIONS

This application is the national stage of PCT/EP2017/053129, filed Feb. 13, 2017, designating the United States and claiming priority from German patent application no. 10 2016 206 471.1, filed Apr. 18, 2016, the entire contents of which are incorporated herein by reference.

### FIELD OF THE INVENTION

The disclosure relates to a connection arrangement between a shaft and a bore, wherein the connection can be produced via a pressing operation and a subsequent soldering operation.

### BACKGROUND OF THE INVENTION

Such connection arrangements are also frequently used in the connection of tubular stubs to a holder. Here, the holder has a bore into which the tubular stub can be pressed. The tubular stub represents the shaft here.

The connection between the stub and the holder is usually a press-solder connection which can be soldered for example in furnaces under protective gas atmosphere, but also in induction furnaces or by flame soldering.

Since the fits between the circular stubs and the likewise circular corresponding bore in the holder fluctuate within the tolerance, it is possible that, with a maximum dimension of the stub and a minimum dimension of the bore, a situation can arise in which there is no soldering gap or only one of insufficient width. This means that the solder can flow only to an insufficient extent, if at all, between the stub and holder and then sufficient wetting of the connection arrangement with solder is no longer provided.

### SUMMARY OF THE INVENTION

It is an object of the invention to provide an improved connection arrangement in such a way that sufficient wetting of the components with solder is provided even in unfavorable circumstances in terms of fit.

The object can, for example, be achieved in that, before the soldering operation, the connection between the pressed-in shaft and bore has at least one gap, wherein the circumferential length of the at least one gap and/or the sum of all the circumferential lengths of the gaps is less than the circumferential length of the bore.

The solder can penetrate into the gaps between the bore and shaft during soldering and thus allow a secure solder connection between the bore and shaft.

In an embodiment of the invention, the gaps can be formed by at least one circular arc-shaped relief.

Since the bore is circular in most cases, the reliefs can be easily produced by being milled out, for example, the reliefs having, for example, a circular arc shape corresponding to the radius of a milling cutter. However, such bores with reliefs can also be readily produced by stamping operations.

In an embodiment of the invention, the at least one gap and/or the gaps between the bore and shaft has/have a maximum gap width between 0.05 and 0.2 mm.

In an embodiment of the invention, the at least one gap and/or the gaps between the bore and shaft has/have a maximum gap width between 0.07 and 0.15 mm.

In an embodiment of the invention, the at least one gap and/or the gaps between the bore and shaft has/have a maximum gap width of 0.1 mm.

With these gap widths, it is possible to achieve a particularly good flow of solder during soldering.

### BRIEF DESCRIPTION OF THE DRAWING

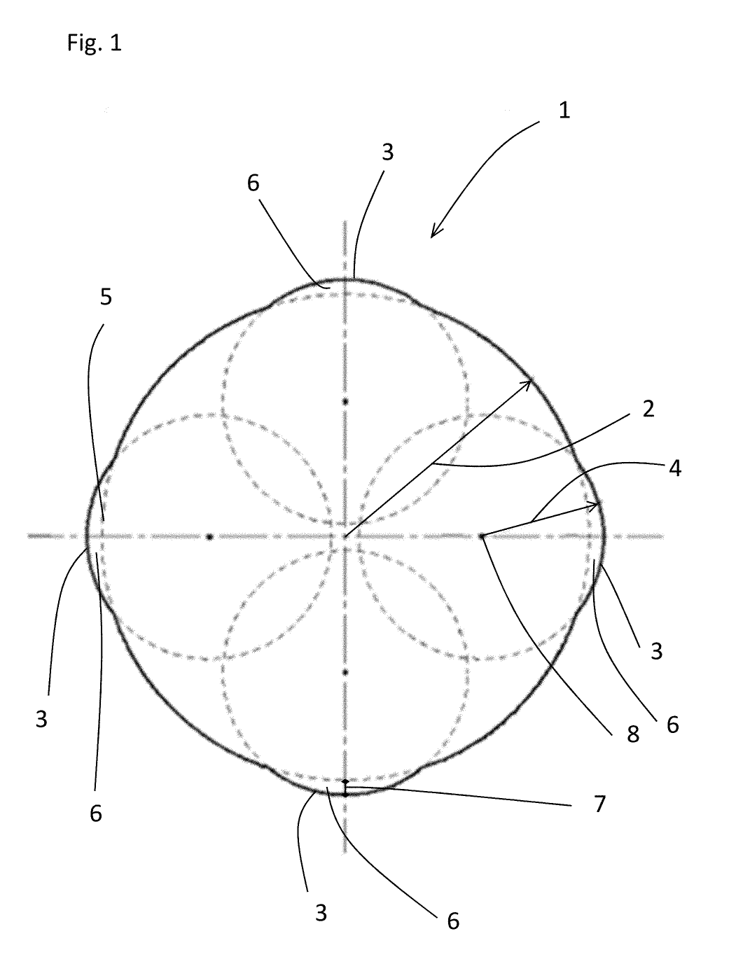

The invention will now be described with reference to the single figure of the drawing (FIG. 1) which shows a bore of a connection arrangement between a shaft and the bore.

### DESCRIPTION OF THE PREFERRED EMBODIMENTS OF THE INVENTION

FIG. 1 shows a bore 1 of a connection arrangement (not represented any more specifically) between a shaft (not represented either) and the bore 1. The bore 1 has a main radius 2 which corresponds to the diameter of the shaft (not represented) in the form of a press fit. Four reliefs 3 are arranged in a uniformly distributed manner over the circumference of the bore 1. The reliefs 3 each have a secondary radius 4, and therefore the reliefs 3 are configured to be circular arc-shaped.

The reliefs 3 are arranged in such a way that in each case a gap 6 delimited by the radii 2 and 4 and having a maximum gap width 7 is formed between an imaginary circle line 5 of the bore 1 in the region of the reliefs 3 and the reliefs 3.

The maximum gap widths 7 and the size of the circular arcs of the reliefs 3 can be individually adapted through the choice of suitable secondary radii 4 and associated imaginary center points 8 of the reliefs 3.

It is understood that the foregoing description is that of the preferred embodiments of the invention and that various changes and modifications may be made thereto without departing from the spirit and scope of the invention as defined in the appended claims.

### REFERENCE NUMERALS

### Part of the Description

1 Bore
2 Main radius of the bore 1
3 Reliefs
4 Secondary radius of the bores 3
5 Imaginary circle line of the bore 1 in the region of the reliefs 3
6 Gap
7 Maximum gap width of the reliefs 3
8 Imaginary center point of the secondary radii 4

1-5. (canceled)

6. A connection arrangement comprising:
a member defining a bore;
a shaft configured to be pressed into said bore;
the connection arrangement being between said shaft and said bore, wherein a connection can be made between said shaft and said bore via a pressing operation and a subsequent soldering operation;
said shaft being configured to be pressed into said bore via said pressing operation;
said bore defining a bore circumferential length;
wherein, before the soldering operation, the connection between said shaft pressed into said bore and said bore defines at least one gap;
said at least one gap having a gap circumferential length; and,
wherein at least one of said gap circumferential length and a sum of all gap circumferential lengths of said at least one gap is less than said bore circumferential length.

7. The connection arrangement of claim 6, wherein said at least one gap is formed by at least one circular arc-shaped relief.

8. The connection arrangement of claim 7, wherein said at least one gap has a maximum gap width between 0.05 millimeters and 0.2 millimeters.

9. The connection arrangement of claim 7, wherein said at least one gap has a maximum gap width between 0.07 millimeters and 0.15 millimeters.

10. The connection arrangement of claim 7, wherein said at least one gap has a maximum gap width of 0.1 millimeters.

11. The connection arrangement of claim 6, wherein said member is a holder.
